(19) United States
(12) Patent Application Publication
(10) Pub. No.: US 2010/0044376 A1
(43) Pub. Date: Feb. 25, 2010

(54) METHOD OF BONDING A MICRIFLUIDIC DEVICE AND A MICROFLUIDIC DEVICE

(75) Inventor: Johan Engström, Uppsala (SE)

Correspondence Address: FULBRIGHT & JAWORSKI, LLP, 1301 MCKINNEY, SUITE 5100, HOUSTON, TX, 77010-3095, US

(73) Assignee: GYROS Patent AB, Uppsala (SE)

(21) Appl. No.: 12/514,354

(22) PCT Filed: Nov. 19, 2007
(86) PCT No.: PCT/SE2007/050862

§ 371 Date: May 11, 2009

Related U.S. Application Data
(60) Provisional application No. 60/866,626, filed on Nov. 21, 2006.

(30) Foreign Application Priority Data
Nov. 21, 2006 (SE) 0602477-2

(51) Int. Cl. B65D 51/00; B32B 37/00; B29C 65/14

(52) U.S. Cl. 220/212; 156/60; 156/272.4

(57) ABSTRACT

An aspect of the present invention includes a microfluidic assembly comprising: a planar substrate, a least a first surface of which has at least one open microchannel structure, a lid-forming sheet material attached with a first surface to said first surface of said planar substrate, said lid-forming sheet material is covering at least a portion of said at least one microchannel structure, wherein said lid-forming sheet material is attached to said planar substrate with a bonding material comprising particles to control the spacing between said substrate and said lid-forming sheet material. Other aspects of the present invention are reflected in the detailed description, figures and claims.

### TECHNICAL FIELD

The present invention relates to the production of microchannel and microcavity systems and to the microchannel and microcavity systems as such, and more particularly to an improved method of bonding a lid to a substrate, where at least one of said substrate and/or lid comprises at least a part of said microchannel system.

### BACKGROUND OF THE INVENTION

Microchannel or microcavity structures are used inter alia chemical analytical techniques, such as electrophoresis and chromatography. A microfluidic device is defined as a device in which one or more liquid aliquots that contain reactants and have volumes in the μl-range are transported and processed in microchannel structures that have a depth and/or width that are/is in the μm-range. The μl-range is ≦1000 μl, such as ≦25 μl, and includes the nl-range that in turn includes the pl-range. The nl-range is ≦5000 nl, such as ≦1000 nl. The pl-range is ≦5000 pl, such as ≦1000 pl. The μm-range is ≦1000 μm, such as ≦500 μm.

A microfluidic device typically contains a plurality of the microchannel structures described above, i.e. has two or more microchannel structures, such as ≧10, e.g. ≧25 or ≧90. The upper limit is typically ≦2000 structures.

Different principles may be utilized for transporting the liquid within a microchannel structure. Inertia force may be used, for instance by spinning the disc. Other useful forces are electrokinetic forces and non-electrokinetic forces other than centrifugal force, such as capillary forces, hydrostatic pressure, pressure created by one or more pumps etc.

The microfluidic device typically is in the form of a disc. The preferred formats have an axis of symmetry (Cₙ) that is perpendicular to or coincides with the disc plane, where n is an integer ≧2, 3, 4 or 5, preferably ∞ (C_{∞}). The disc thus may have various polygonal forms such as rectangular. The preferred sizes and/or forms are similar to the conventional CD-format, e.g. sizes in the interval from 10% up to 300% of a circular disc with the conventional CD-radii (12 cm). If the microchannel structures are properly designed and oriented, spinning of the device about a spin axis that typically is perpendicular or parallel to the disc plane may create the necessary centrifugal force for causing parallel liquid transport within the structures. In the most obvious variants at the priority date, the spin axis coincides with the above-mentioned axis of symmetry.

In preferred microchannel structures, capillary force is used for introducing liquid through an inlet port up to a first capillary valve whereafter centrifugal force or some other non-passive driving means is applied for overcoming the resistance for liquid flow at the valve position. The same kind of forces/driving means is also used for overcoming capillary valves at other positions.

The microfluidic device may be circular and of the same dimension as a conventional CD (compact disc).

In order to facilitate efficient transport of liquid between different functional parts, inner surfaces of the parts should be wettable (hydrophilic), i.e. have a water contact angle ≦90°, preferably ≦60° such as ≦50° or ≦40° or ≦30° or ≦20°. These wettability values apply for at least one, two, three or four of the inner walls of a microconduit. The wettability or hydrophilicity, in particular in inlet arrangements, should be adapted such that an aqueous liquid will be able to fill up an intended microcavity/microconduit by capillarity (self suction) once the liquid has started to enter the cavity/microconduit. A hydrophilic inner surface in a microchannel structure may comprise one or more local hydrophobic surface breaks (water contact angle ≧90°). Such a break may wholly or partly define a passive/capillary valve, an anti-wicking means, a vent to ambient atmosphere etc. Contact angles refer to values at the temperature of use, typically +25° C., and are static. See WO 00056808, WO 01047637 and WO 02074438 (all Gyros A B).

Microchannels/microcavities may be arranged on one side of a substrate and thereafter covered by a lid in order to create a closed microcavity, of course said microcavity and/or said microchannel may be provided with at least one inlet and at least one outlet. Said substrate may be of the same thickness as an ordinary compact disc, i.e., in the range of 1 mm. Said substrate may be regarded as semi flexible, i.e., the disc is bendable but may not change form if it is supported by different topologies.

The lid may be regarded as flexible, i.e., if you put the lid on two different topologies the lid will take two different forms. It is advantageous to use a thicker substrate in which you may define the microchannels and on top of said substrate a flexible lid in form of a film, which may easily adapt itself to any curling and/or unevenness of the substrate that may be present. In this way you may increase the probability of attaching the lid to each and every portion of the substrate that one want to.

When going down in channel sizes and liquid volumes, the demands on channel uniformity between different micro channel structures becomes extremely stringent in order to obtain reliable, reproducible and accurate results.

We have recognized that the conventional methods easily cause bonding material, in particular adhesives, to spread into the micro channels in an uncontrolled manner when the substrates are pressed together during the actual bonding process. The risk for creation of irregularly occurring constrictions and/or complete clogging of a micro channel structure is significant and increases with amount of bonding material, in particular liquid adhesives, and contact area between the two substrates.

Further, there is a need in the art for increasing the bonding pressure in order to achieve better attachment of the lid to the substrate and/or to even out possible uneven substrates and/or lids. However, increasing the pressure in combination with smaller microchannel structures may cause problems such as clogged structures, non-equal volumes of cavities, restricted and/or non-equal flow properties etc.

### SUMMARY OF THE INVENTION

An object of the present invention is to eliminate or at least reduce the problem with clogged microchannel structures, non-equal volumes of cavities, restricted and/or non-equal flow properties etc. when attaching a substrate and a lid together via bonding, where at least one of the substrate and/or lid comprises at least a part of a said microchannel.

The foregoing and other objects, apparent to the skilled man from the present disclosure, are met by the invention as claimed.

In a first example of an embodiment of the invention a microfluidic assembly comprises: a planar substrate, a least a first surface of which has at least one open microchannel structure, a lid-forming sheet material attached with a first surface to said first surface of said planar substrate, said lid-forming sheet material covering at least a portion of said at least one microchannel structure, wherein said lid-forming sheet material is attached to said planar substrate with a bonding material comprising a bonding agent and particles to control the spacing between said substrate and said lid-forming sheet material.

In another example of an embodiment of the invention said particles have a size within the range of 0.1-20 μm.

In still another example of an embodiment of the invention said particles are transparent.

In yet another example of an embodiment of the invention a concentration of particles in said adhesive is in the range of 1-90%.

In still another example of an embodiment of the invention the shape of a said particle is spherical.

In still another example of an embodiment of the invention said substrate and or said lid-forming sheet material is made of a polymeric material.

In still another example of an embodiment of the invention said lid-forming sheet material and/or said planar substrate is transparent.

In still another example of an embodiment of the invention said bonding material is heat sensitive.

In still another example of an embodiment of the invention said particles are made of inorganic, polymeric or inductive responsive material.

In still another example of an embodiment of the invention said bonding material is cured with IR, UV, EUV, or DUV waves.

Another aspect of the invention provides for a method for manufacturing of microfluidic devices comprising at least one enclosed microchannel structure, said manufacturing comprising joining a substrate surface I of a first generally planar substrate I to a substrate surface II of a second generally planar substrate II via a bonding material, comprising the actions of: providing said bonding material on at least a part of one of substrate surface I and/or II, providing numerous particles in said bonding material, bonding said surface I of substrate I to said surface II of said substrate II, defining the space between substrate I and substrate II by the size of the particles in said bonding material.

In another example of an embodiment of a method according to the invention at least one microchannel in the microfluidic device comprises parts in which the width and/or depth is less than 200 μm.

In another example of an embodiment of a method according to the invention said bonding material comprises an adhesive.

In still another example of an embodiment of a method according to the invention said method further comprising the action of: providing a magnetic field during the bonding of said surface I of substrate I to said surface II of substrate II so that particles made of inductive responsive material in said bonding material will be heated.

Other aspects of the present invention are reflected in the detailed description, figures and claims.

### BRIEF DESCRIPTION OF THE DRAWINGS

FIG. 1a depicts a sectional view of a first example of an embodiment of a part of a microfluidic assembly according to the present invention.

FIG. 1b depicts a sectional view of a second example of an embodiment of a part of a microfluidic assembly according to the present invention.

FIG. 1c depicts a view from above of an example of an embodiment of a microfluidic assembly.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

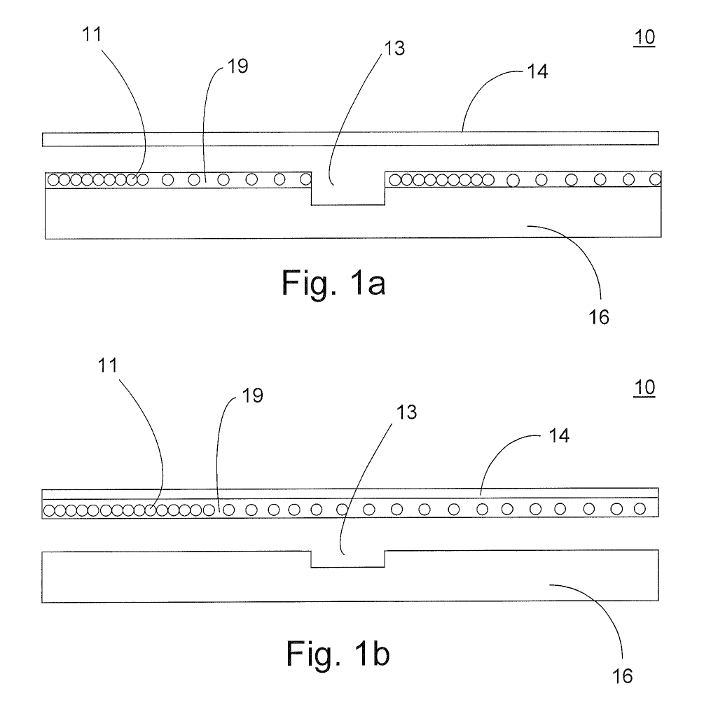

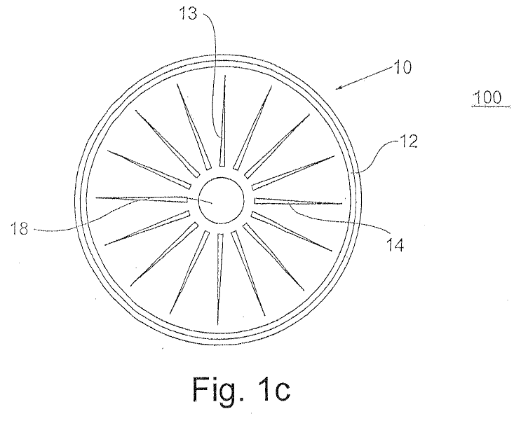

FIGS. 1a and 1b depicts sectional views of an example of an embodiment of a part of a microfluidic assembly 10 according to the present invention. Said assembly 10 comprises a substrate 16, a lid-forming sheet material 14, microchannel 13 and bonding material 19.

The substrate may be made from different materials, such as plastics including elastomers, such as rubbers including silicone rubbers (for instance poly dimethyl siloxane) etc (Polymethyl methacrylate) PMMA, polycarbonate and other thermoplastic materials, i.e., plastic material based on monomers which comprises polymerisable carbon-carbon double or triple bonds and saturated branched straight or cyclic alkyl and/or alkynene groups. Typical examples are Zeonex™ and Zeonor™ from Nippon Zeon, Japan.

The substrate 16 and the lid-forming sheet material 14 may be attached by means of bonding. The bonding material may be part of, or separately applied to, a surface of said substrate 16 (FIG. 1a) and/or a surface of said lid-forming sheet material 14 (FIG. 1b). The bonding material comprises a bonding agent which may be the same plastic material as is present in the substrate 16, provided this plastic material can work as a bonding material. Other useful bonding agents are various kinds of adhesives, which are suitable for adhering to the material in the substrate 16 and the lid-forming sheet material 14 and are also suitable for the intended use of the final device. Typical adhesives may be selected amongst melt-adhesives, and curing adhesives etc. Curing adhesives may be thermo-curing, moisture-curing, UV-curing and bi- three- and multi-component adhesives.

Said bonding material comprises particles 11, having inter alia the functionality of defining the space between the substrate 16 and the lid-forming sheet material 14 when they have been bonded together. In the example embodiments in FIGS. 1a and 1b said particles are spherical. However, any shape of said particles may be used, such as cubic, tetrahedral, elliptic, irregular, fibrous etc. In order to have the spacing between said substrate and said lid-forming sheet material well defined said particles 11 need to be more or less about the same size, for example, if one needs a spacing between the substrate 16 and the lid-forming sheet material 14 which is 20 μm, each particle need to be in a size range of for instance 0.1 μm-20 μm. If the spacing required is 5 μm then particles in a size range of for instance 1-5 μm could be used. If another spacing is needed between said substrate and said lid-forming sheet material another size of the particles may be chosen, the size of which serves the purpose of defining the thickness of the space between those layers.

The particles may be applied to the bonding agent prior to providing said bonding material onto said substrate and/or said lid-forming sheet material. The bonding agent may also be applied firstly onto said substrate and/or said lid-forming sheet material without said particles and thereafter, when the bonding material has been attached onto said substrate and/or said lid-forming sheet material said particles are attached to it to form said bonding material. Said particles may be spread over the surface in a randomly fashion or in a regular fashion, for instance according to a Cartesian grid.

The bonding material may be applied onto said substrate and/or said lid-forming sheet material according to well known methods in the art, such as lamination of the bonding material, screen printing, offset printing, dipping the substrate in the bonding material, spin-application etc. In order to reduce the risk that surplus bonding material is forced into the microchannels and cavities in the structure during bonding of a lid to the substrate, the depth of the layer of bonding material applied between the lid and substrate, the size of the particles in the bonding material and the proportion by volume of particles in the bonding material should be controlled. In the case where that the microchannels and cavities extend in the substrate to a maximum depth D then the bonding material is applied in a layer which preferably is less than 50% of depth D. More preferably the bonding material is applied in a layer which is less than 40% of depth D. Even more preferably the bonding material is applied in a layer which is less than 30% of depth D. Even more preferably the bonding material is applied in a layer which is less than 20% of depth D. More preferably the bonding material is applied in a layer which is less than 10% of depth D. It is also conceivable that with deep structures, e.g. channels, chambers or the like that are 100 μm or more deep, the depth of the layer of bonding material could be as low as 1% of depth D.

Preferably the particles comprises at least 20% of the volume of the bonding material, more preferably at least 30% of the volume of the bonding material, even more preferably at least 40% of the volume of the bonding material, more preferably at least 50% of the volume of the bonding material. If spherical particles are used which have nominally the same diameter as the desired bonding layer thickness e.g. 10 μm for a 10 μm thick bonding layer, and the population of particles comprises only particles of substantially the same size, then, if air spaces between particles are to be avoided the maximum theoretical percentage by volume of particles in the bonding material is limited to the theoretical maximum allowed by packing theory—approximately 52%. However a greater percentage of particles by volume can be achieved by providing particles of different sizes in appropriate ratios, for example, for a bonding layer intended to be 20 μm thick, an embodiment in accordance with the present invention of a mixture of particles could comprise 50% by volume a first population of particles with a nominal diameter of 20 μm, 25% by volume a second population of particles with a nominal diameter of one quarter the size of the larger particles i.e. 5 μm or less and 25% by volume bonding agent. These smaller particles can partially fill the spaces between the larger particles which occur in the bonding layer. Preferably the total percentage by volume of particles does not exceed 90% of the volume of the bonding material. Other proportions of particle populations are also conceivable in bonding material, for example, a first population of 20-50% by volume comprising particles of a first nominal size, a second population of 20-50% by volume comprising particles of a second nominal size which is one third or less of the first nominal size, a third population of 5-20% by volume comprising particles of a third nominal size which is one third or less of the second nominal size, and at least 1% adhesive or other bonding agent.

The particles may be manufactured in the same material as the material used in the substrate and/or the lid-forming sheet material. Said particles may also be made of another material than the material used in the substrate and/or the lid-forming sheet material, for instance ceramic material, metals, semiconducting material, glass, inductive responsive material etc. The particles may be transparent to visible light or to a given wavelength range, for instance Infrared, UV, DUV, EUV etc. The particles may also be semi-transparent to said wavelengths or non-transparent to said wavelengths.

When using inductive responsive particles in combination with thermo glue as a bonding material, a magnetic field may be applied during the bonding process instead of ordinary heating of bonding equipment, i.e., resistive heating. The magnetic field will interact with the inductive responsive particles and heat the thermo glue and thereby welding the bonding material from inside the assembly. One may adapt the strength of the magnetic field in order to accomplish a well-defined temperature of the thermo glue, which is needed for the bonding process.

A number of particles in said bonding material may be defined as the percentage of volume. In one example of an embodiment of the present invention said percentage of volume of particles in said bonding material is in the range of 1-90%. In another embodiment said range is 20-80%, in yet another embodiment said range is 30-70%, in still another embodiment said range is 10-50%, in yet another example embodiment said range is 50-90%.

Introducing particles in the bonding material may not only serve the function of defining the space between the substrate and the lid-forming sheet material. The function of particles would also be to reduce the amount of bonding material that has the possibility to block the narrow microfluidic channels/cavities when pressing the substrate and the lid-forming sheet material together. It will be possible to use higher pressure when joining the substrate and the lid-forming sheet material together, because the particles will act as a restriction for the adhesive to flow into the microchannels. By using higher pressure, there will also be possible to bond microstructured material, such as the substrate, that are less planar or have undesired defect areas without plastic material. Particles in the bonding material will further make it possible to apply less amount of bonding material, since said bonding material comprises a certain percentage of particles. Yet another functionality that said particles in the bonding material may serve, is to control the physical properties of the bonding material, as for example viscosity. A higher viscosity may be accomplished by a higher percentage of volume of particles.

The lid-forming sheet material 14 may be manufactured by the same types of materials as the substrate 16. This material is not critical as long as it is compatible with the adhesive principle etc. However, one may choose one type of material in the substrate 16 to be bonded with another type of material in the lid-forming sheet material 14. The lid-forming sheet material may be in the form of a laminated sheet and relatively thin compared to the substrate 16, which substrate 16 comprises the microchannel structures 13. In one embodiment the thickness of the lid-forming material 14 is half of the thickness of the substrate 16. In another embodiment the thickness of the lid-forming material 14 is ¼ of the thickness of the substrate 16. In yet another embodiment the thickness of the lid-forming material 14 is ⅛ of the thickness of the substrate 16. In one embodiment the thickness of the lid-forming material 14 is 10% of the thickness ofthe substrate 16. The lid-forming material may have a thickness range of 10 μm-2 mm, more preferably between 20 μm-400 μm. Different thickness ranges may apply to different materials in order to have a semi-flexible lid-forming sheet material. The substrate may have a thickness range of 100 μm-10 mm, more preferably between 400 μm-2 mm.

The shape of the microfluidic assembly is according to the example embodiments circular. However, any suitable form of said microfluidic assembly may be used, such as triangular, rectangular, octagonal, or polygonal.

The liquid flow may be driven by capillary forces, and/or centripetal force, pressure differences applied externally over a microchannel structure and also by other non-electrokinetic forces that are externally applied and cause transport of the liquid. Also electroendosmosis may be utilized for creating the liquid flow.

When the microfluidic structure is circular, the microchannel structures may be arranged radially with an intended flow direction from an inner application area radially towards the periphery of the disc. In this variant, the most practical way of driving the flow is by capillary action, centripetal force (spinning the disc).

The size of the disc may be the same as an ordinary CD, although larger or smaller sizes may be used.

The microchannels may have different sections with different characteristics such as hydrophobicity and hydrophilicity and different applications such as metering, volume defining sections, affinity binding sections and detections areas etc well known in the art.

A width and depth of microchannels and microcavities may vary along its structure. At least one channel in the microfluidic structure may have a depth and/or width which lie within the range of 1-800 μm.

The microfluidic assembly 100 depicted in FIG. 1c is circular and adapted for rotation about its central hole 18. Fluid inlets may in this embodiment be arranged towards the central hole 18 of the assembly 100. A fluid reservoir may be arranged towards the circumference of the assembly 100. Channels 14 may be of suitable dimensions to enable capillary forces to act upon the fluid within the channel.

Hydrophobic valves may be arranged one or a plurality of the channels. Fluid may be fed into the inlet and will then be sucked down the channel by capillary action until it reaches the valve, past which it cannot flow until further energy is applied. This energy may for instance be provided by centrifugal force created by rotating the microfluidic assembly 100.

When RPM (Revolution Per Minute) of the microfluidic assembly is increased the pressure of the fluid acting upon surfaces of the second fluid cavity 406 is increased. At a certain RPM the pressure may be high enough for breaking the bonding of the lid-forming sheet material to the substrate and thereby causing a leakage 414 from said second fluid cavity to said first fluid reservoir 410. Typical RPM ranges is 0-8000 RPM but higher RPM may be used such as 10 000, 15 000 or 20 000.

The microchannels and microcavities may be manufactured according to well known methods in the art, for instance according to a method which is illustrated in EP 1121234.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A microfluidic assembly comprising:
a planar substrate, a least a first surface of which has at least one open microchannel structure,
a lid-forming sheet material attached with a first surface to said first surface of said planar substrate, said lid-forming sheet material is covering at least a portion of said at least one microchannel structure, wherein said lid-forming sheet material is attached to said planar substrate with a bonding material comprising particles to control the spacing between said substrate and said lid-forming sheet material.

2. The microfluidic assembly according to claim 1, wherein said particles have a size within the range of 0.1-20 μm.

3. The microfluidic assembly according to claim 1, wherein said particles are transparent.

4. The microfluidic assembly according to claim 1, wherein the proportion of particles in said bonding material is in the range of 1-90% by volume.

5. The microfluidic assembly according to claim 1, wherein said particles are spherical.

6. The microfluidic assembly according to claim 1 wherein said particles comprise a mixture of particles of two different nominal sizes.

7. The microfluidic assembly according to claim 1, wherein said lid-forming sheet material and/or said planar substrate is transparent.

8. The microfluidic assembly according to claim 1, wherein said bonding material is heat sensitive.

9. The microfluidic assembly according to claim 1, wherein said bonding material is cured with IR, UV, EUV, or DUV waves.

10. The microfluidic assembly according to claim 1, wherein said particles are made of inorganic material.

11. The microfluidic assembly according to claim 1, wherein said particles are made of inductive responsive material.

12. The microfluidic assembly according to claim 1, wherein said particles are made of polymeric material.

13. A method for manufacturing of microfluidic devices comprising at least one enclosed microchannel structure, said manufacturing comprising joining a substrate surface I of a first generally planar substrate I to a substrate surface II of a second generally planar substrate II via a bonding material, comprising the actions of
i) providing said bonding material on at least a part of one of substrate surface I and/or II,
ii) providing numerous particles in said bonding material,
iii) bonding said surface I of substrate I to said surface II of said substrate II,
iv) defining the space between substrate I and substrate II by the size of the particles in said bonding material.

14. The method according to claim 13, wherein at least one microchannel in the microfluidic device comprises parts in which the width and/or depth is less than 200 μm.

15. The method according to claim 13, wherein said bonding material is an adhesive.

16. The method according to claim 13, further comprising the action of:
providing a magnetic field during the bonding of said surface I of substrate I to said surface II of substrate II so that particles made of inductive responsive material in said bonding material will be heated.

17. The method of claim 15 wherein action ii) further comprises the step of providing at least two populations of particles, wherein the nominal size of the particles of a first population of particles is different to the nominal size of the particles of a second population of particles.
